(19) United States
(12) Patent Application Publication
(10) Pub. No.: US 2022/0164696 A1
(43) Pub. Date: May 26, 2022

(54) AUTOMATICALLY TRAINING AN ANALYTICAL MODEL

(71) Applicant: Capital One Services, LLC, Mclean, VA (US)

(72) Inventors: Xue LI, Lewisville, TX (US); Bing LIU, Frisco, TX (US); Yunjin SUN, Jersey City, NJ (US); Ruikai CAO, Mckinney, TX (US); Yun ZHOU, Alien, TX (US); Ryan COLE, Dallas, TX (US); Dimas GONZALES, Dallas, TX (US)

(73) Assignee: Capital One Services, LLC, McLean, VA (US)

(21) Appl. No.: 17/101,796

(22) Filed: Nov. 23, 2020

(51) Int. Cl. G06N 20/00; G06F 9/48

(52) U.S. Cl. CPC G06N 20/00; G06F 9/4881

(57) ABSTRACT

Described herein is a method, system, and apparatus, or combinations and sub-combinations thereof for automatically training an analytical model. In a given embodiment, a server may generate a model dependency structure, including a definition for each dependency relationship between various analytical models. The server generates a script using the model dependency structure. The script may identify a definition of a dependency relationship between the first analytical model and a second analytical model based on the model dependency structure. The script may generate and transmit an instruction to the task scheduler to train the first analytical model.

### BACKGROUND

Entities such as corporations, banking institutions, and governmental institutions often implement large-scale analytical models to predict and identify patterns of various aspects of an entity's operation. The patterns may be projections or tendencies of an entity when performing its day-to-day operations using a group of rules, regulations, or methodologies. As a result, an entity may desire to have some insight into these patterns so that they can revise any rules, regulations, or methodologies implemented by the entity that may adversely affect the entity.

The aspects of an entity's operation may include asset valuations, risks associated with the entity, budget forecasting, human resource data, or the like. For example, an entity may determine a pattern associated with the entity's spending over a period of time, using the large-scale analytical model. The large-scale analytical model may include multiple layers of sub-analytical models, which are dependent on one another. That is, a given sub-analytical model may be trained using an output of a different sub-analytical model. In other words, the given sub-analytical model may be dependent on the different sub-analytical models. These dependencies may span across multiple layers, and a sub-analytical model may be dependent on multiple different sub-analytical models. This creates complex dependency structures among the sub-analytical models.

Due to the numerous sub-analytical models, developers may need to experiment with an individual or a subset of analytical models. As such, developers may want to train and execute the individual or subset of the analytical models, which the developer wants to experiment with, rather than training each analytical model. Conventionally, when attempting to train an individual or subset of sub-analytical models, a developer would have to identify all the dependencies of the individual or subset of sub-analytical models manually. Furthermore, a developer would have to generate the instruction manually for training and executing the individual or subset of sub-analytical models based on the respective dependencies. Due to the complexities of these dependencies, such manual operations result in an error-prone and burdensome process.

### BRIEF DESCRIPTION OF THE FIGURES

The accompanying drawings, which are incorporated herein and form part of the specification, illustrate the present disclosure and, together with the description, further serve to explain the principles of the disclosure and enable a person skilled in the relevant art to make and use the disclosure.

FIG. 1 is a block diagram of an example environment in which systems and/or methods described herein may be implemented according to an example embodiment.

FIG. 2 is a block diagram illustrating a main analytical model, according to some embodiments.

FIG. 3 is a block diagram of an example model dependency structure, according to example embodiments.

FIG. 4 is a flowchart illustrating a process for generating a script using a model dependency structure, according to some embodiments.

FIG. 5 is a flowchart illustrating a process for training an analytical model, according to some embodiments.

FIG. 6 is a flowchart illustrating a process for training an analytical model, according to some embodiments.

FIG. 7 is a block diagram of example components of a device according to some embodiments.

The drawing in which an element first appears is typically indicated by the leftmost digit or digits in the corresponding reference number. In the drawings, like reference numbers may indicate identical or functionally similar elements.

### DETAILED DESCRIPTION

Described herein is a method, system, and apparatus, or combinations and sub-combinations thereof for automatically training an analytical model.

In a given embodiment, a server may generate a model dependency structure representing multiple layers of sub-analytical models and including a definition for each dependency relationship between various sub-analytical models. The sub-analytical models may be part of a main analytical model. The main analytical model may be configured to identify patterns about different aspects of an entity's operation. Aspects may include asset valuations, risks associated with the entity, budget forecasting, human resource data, or the like. The main analytical model may use an output generated by each sub-analytical model to identify the patterns about various aspects about the entity. Each definition indicates that an output of a given analytical model is used to train and execute a different analytical model. The server generates a script using the model dependency structure. The script may be an automated script configured to generate instructions for a task scheduler for executing one or more of the plurality of analytical models using the model dependency structure.

The server may receive a request to train a first analytical model. Accordingly, the server may execute the script to generate an instruction to train the first analytical model. The script may identify a definition of a dependency relationship between the first analytical model and a second analytical model based on the model dependency structure. The first definition indicates that an output of the second analytical model is used to train the first analytical model. The script may generate and transmit the first instruction to the task scheduler to train the first analytical model. The instruction may indicate an order to execute the first and second analytical model based on the definition. The order may indicate executing the second analytical model before the first analytical model.

The above configuration allows for efficiently and automatically identifying dependencies between analytical models, determining an order in which the analytical models should be executed, and generating an instruction for a task scheduler to execute the analytical models in the desired order. By doing so, a developer may automatically train an analytical model, independent of other unrelated analytical models. This eliminates the manual process of identifying dependencies of the analytical models, determining an order the analytical models are to be executed, and generating individual instructions for the task scheduler. Additionally, the above configuration also eliminates having to train and execute each analytical model. Therefore, the above configuration saves operational resources and provides an efficient improvement over conventional systems.

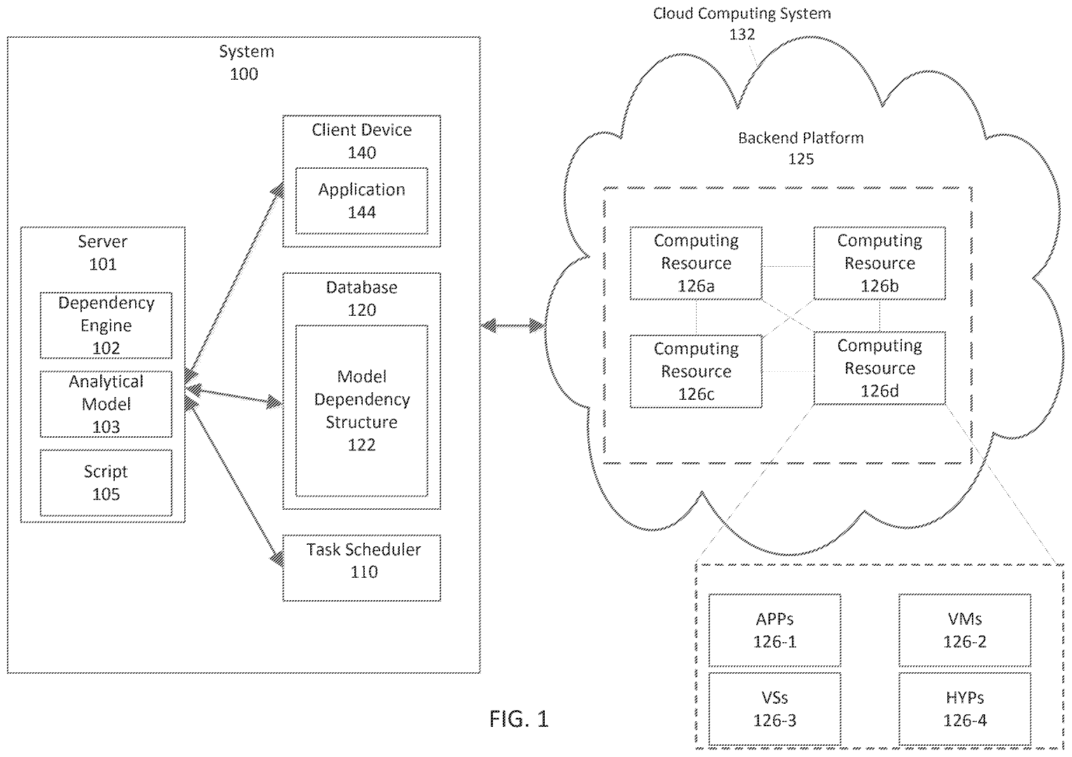

FIG. 1 illustrates an example environment in which systems and/or methods for generating model structures are implemented according to some embodiments. The environment may include system 100 and cloud computing system 132. System 100 may include server 101, client device 140, database 120, and task scheduler 110.

Task scheduler 110 may be a workflow management system. Task scheduler 110 may schedule and execute tasks based on a defined order, dependency, priority, or resources. Task scheduler 110 may receive an instruction. The instruction may indicate the task to execute and any dependencies of the task, as well as the order of the task to be executed based on the dependencies. Task scheduler 110 may execute the tasks in the defined order based on the dependencies. In system 100, tasks may be executing and training sub-analytical models. Example task schedulers include LUIGI (developed by SPOTIFY) and AIRFLOW (developed by APACHE).

Server 101 may include a dependency engine 102, analytical model 103, and script 105. Dependency engine 102 may be an executable application, configured to interface with task scheduler 110, client device 140, and database 120.

Analytical model 103 may be a main analytical model, which may include other analytical models (or sub-analytical models). Analytical model 103 may be configured to execute the sub-analytical models. Analytical models 103 may use outputs generated by the sub-analytical models to identify a pattern of an aspect about an entity. The sub-analytical models may span across multiple layers. One sub-analytical model or layer of sub-analytical models may depend on an output of another sub-analytical model or layer of sub-analytical models.

Analytical model 103 and sub analytical models may be predictive models. For example, analytical model 103 may be configured to determine an entity's projected inventory of items using outputs of the sub-analytical models. For example, the entity may be a retail store with brick and mortar stores and an online store. The sub-analytical models may be grouped based on a common attribute. An attribute may be a value that provides insight into an area of an entity's operation. Furthermore, the attribute may be used to determine the output of analytical model 103. Each attribute is made up of elements. An element is a value that is determined using an entity's data associated with the attribute. The values of the elements may be used to determine a given attribute.

For example, an attribute may be an input parameter used to calculate the output of main analytical model 103, where each attribute may be determined using various elements.

Therefore, each sub-analytical model may be trained and executed to identify an element using an entity's data and various analytical algorithms (e.g., logical regression, non-linear, or the like). Each identified element from the group of sub-analytical models may be used to identify an attribute. Analytical model 103 may be trained and executed to generate an output using the identified attributes.

For example, the attributes, purchases, returns, and purchase orders may be input parameters for determining a projected inventory of items for an entity. In this regard, a subset of sub-analytical models may be grouped into a purchase group. The subset of sub-analytical analytical models in the purchase group may be configured to identify elements associated with the purchase attribute of an entity. For example, elements of the purchase group may include in-store sales, online sales, bulk sales, or the like. Each of these elements may contribute to determining the purchase attribute.

A different subset of sub-analytical models may be grouped into a return group. Each sub-analytical model in the subset of sub-analytical models in the return group may identify an element associated with the return attribute of an entity.

Another subset of sub-analytical models may be grouped into a purchase order group. Each sub-analytical model in the subset of analytical models in the purchase order group may be configured to generate an element associated with the purchase order attribute of an entity.

Each sub-subset of sub-analytical models may be trained and executed to identify a given attribute. An attribute may provide insight into a particular area of an entity. For example, the attribute may be a projection for the purchase orders of an entity. The value of the attributes may be used to train and execute analytical model 103. Analytical model 103 may determine a pattern about an aspect of an entity's operation. The pattern may be a projection or tendency of the entity for a particular aspect. For example, analytical model 103 may be trained and executed to project the entity's expected inventory of items over a period of time.

Furthermore, each sub-analytical model of the subset of sub-analytical models within a given group may be configured to identify an element for different categories. The different categories may include different departments or lines of businesses of an entity. For example, the lines of business of an entity may include east coast stores, west coast stores, mid-west stores, outlet stores, or the like. Therefore, each sub-analytical model of the subset of sub-analytical models within the purchase group may identify an element associated with each line of business. For example, an element may be projected in-store sales for lines of business, including east coast stores, west coast stores, mid-west stores, outlet stores, or the like.

The identified elements may contribute to determining the purchase attribute for each line of business. The purchase attribute corresponds with elements of the entity that may contribute to the sales or moving out of inventory from an entity. For example, the purchases attribute includes elements, such as in-store sales, online sales, and bulk sales. These elements may decrease the inventory from an entity (e.g., retail store). Therefore, a higher projection of purchases will result in a lower projection of the inventory. Furthermore, a lower projection of the purchase attribute value may result in a higher projection of inventory. Furthermore, each sub-analytical model of the subset of sub-analytical models within the return group may identify an element associated with each line of business. The identified elements may contribute to determining the return attribute for each line of business. Additionally, each sub-analytical model of the subset of sub-analytical models within the purchase order group may identify an element associated with each line of business. The identified elements may contribute to determining the purchase order attribute for each line of business.

The analytical model 103 may be trained using the outputs of the sub-analytical models. Each sub-analytical model may be trained using the outputs of other sub-analytical models.

Script 105 may be an automated script configured to generate instructions for task scheduler 110. As described above, different types of task schedulers may be implemented in system 100. Each type of task scheduler may use different formats or syntax to execute instructions. Script 105 may be configured to identify the type of task scheduler 110 and generate an instruction using the syntax and format of the type of task scheduler 110.

Client device 140 may include application 144. Application 144 may be used to interface with server 101 and dependency engine 102. Dependency engine 102 may receive requests from and transmit responses to application 144.

Database 120 may include a model dependency structure 122. Model dependency structure 122 may store the dependencies of the sub-analytical models. Model dependency structure 122 may be updated periodically as the dependencies of the sub-analytical models are updated. Model dependency structure 122 may be a dependency graph such as a directed acyclic graph (DAG). The vertices of the graph may be sub-analytical models, and the edges may be the dependency relationships between the sub-analytical models. As such, model dependency structure 122 may be stored as a graph object in database 120.

The devices of the environment may be connected through wired connections, wireless connections, or a combination of wired and wireless connections. In an example embodiment, one or more portions of a network may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

Backend platform 125 may include a server or a group of servers. In an embodiment, backend platform 125 may be hosted in cloud computing system 132. It may be appreciated that backend platform 125 may not be cloud-based, or may be partially cloud-based.

Cloud computing system 132 includes an environment that delivers computing as a service, whereby shared resources, services, etc. may be provided to system 100. Cloud computing system 132 may provide computation, software, data access, storage, and/or other services that do not require end-user knowledge of a physical location and configuration of a system and/or a device that delivers the services. Cloud computing system 132 may include computer resources 126a-d. Server 101 and database 120 may reside inside cloud computing system 132. Alternatively, server 101 and database 120 may reside partially outside cloud computing system 132 or entirely outside cloud computing system 132.

Each computing resource 126a-d includes one or more personal computers, workstations, server devices, or other types of computation and/or communication devices. Computing resource(s) 126a-d may host backend platform 125. The cloud resources may include compute instances executing in cloud computing resources 126a-d. Cloud computing resources 126a-d may communicate with other cloud computing resources 126a-d via wired connections, wireless connections, or a combination of wired and wireless connections.

Computing resources 126a-d may include a group of cloud resources, such as one or more applications (“APPs”) 126-1, one or more virtual machines (“VMs”) 126-2, virtualized storage (“VS”) 126-3, and one or more hypervisors (“HYPs”) 126-4.

Application 126-1 may include one or more software applications that may be provided to or accessed by server 101 and client device 140. For example, applications 126-1 may include dependency engine 102 and application 144. In an embodiment, server 101 may reside outside cloud computing system 132 and may execute applications like dependency engine 102 locally. Alternatively, application 126-1 may eliminate a need to install and execute software applications on server 101 or client device 140. Application 126-1 may include software associated with backend platform 125 and/or any other software configured to be provided across cloud computing system 132. Application 126-1 may send/receive information from one or more other applications 126-1, via Virtual machine 126-2.

Virtual machine 126-2 may include a software implementation of a machine (e.g., a computer) that executes programs like a physical machine. Virtual machine 126-2 may be either a system virtual machine or a process virtual machine, depending upon the use and degree of correspondence to any real machine by virtual machine 126-2. A system virtual machine may provide a complete system platform that supports the execution of a complete operating system (OS). A process virtual machine may execute a single program and may support a single process. Virtual machine 126-2 may execute on behalf of a user and/or on behalf of one or more other backend platforms 125 and may manage the infrastructure of cloud computing system 132, such as data management, synchronization, or long-duration data transfers.

Virtualized storage 126-3 may include one or more storage systems and/or one or more devices that use virtualization techniques within the storage systems or devices of computing resource 126. With respect to a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how administrators manage storage for end users. File virtualization may eliminate dependencies between data accessed at a file-level and location where files are physically stored. This may enable optimization of storage use, server consolidation, and/or performance of non-disruptive file migrations.

Hypervisor 126-4 may provide hardware virtualization techniques that allow multiple operations systems (e.g., “guest operating systems”) to execute concurrently on a host computer, such as computing resource 126. Hypervisor 126-4 may present a virtual operating platform to the guest operating systems and may manage the execution of the guest operating systems multiple instances of a variety of operating systems and may share virtualized hardware resources.

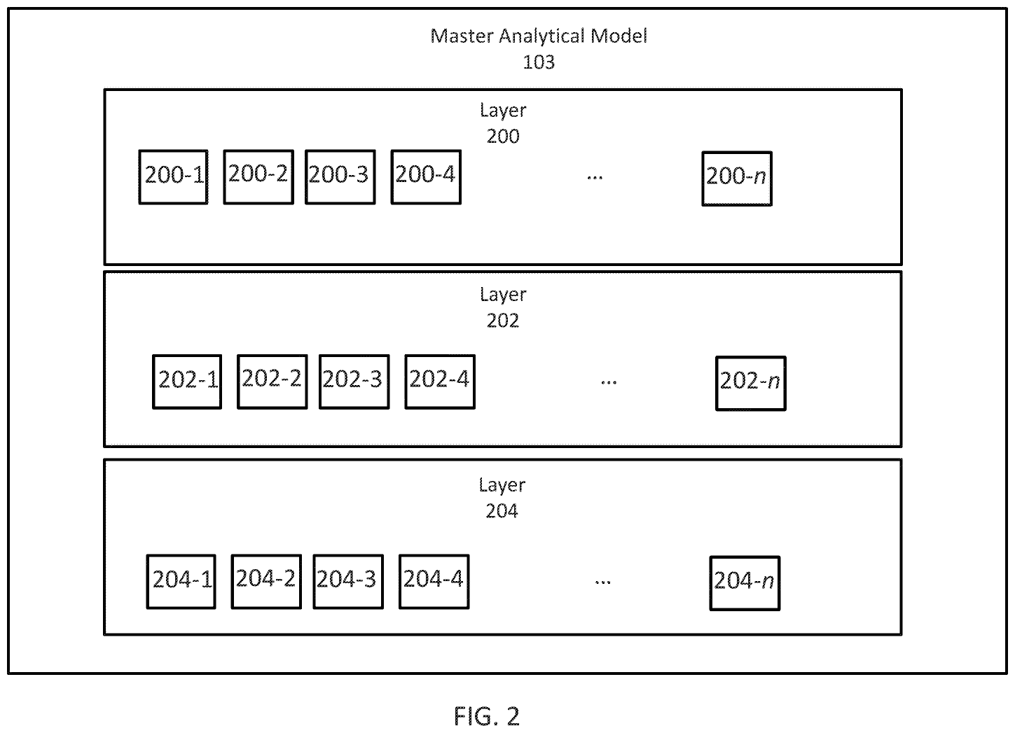

FIG. 2 is a block diagram illustrating analytical model 103, according to some embodiments. FIG. 2 will be described with reference to FIG. 1.

Analytical model 103 may include layers 200, 202, and 204. Each layer may include analytical models. These analytical models may be sub-analytical models. For example, layer 200 may include sub-analytical models 200-1-200-n. Layer 202 may include sub-analytical models 202-1-202-n. Layer 204 may include sub-analytical models 204-1-204-n. Each of the sub-analytical models may be configured to generate an output related to analytical model 103. Each of the sub-analytical models may use a different modeling technique, such as logistic regression, non-linear regression, or the like.

As a non-limiting example, analytical model 103 may be configured to determine a projected inventory of items for an entity. The projected inventory of items for an entity may be determined based on attributes such as purchases, returns, and purchase orders. Each attribute may be determined based on elements. For example, the purchase attribute may be determined based on elements, including in-store sales, online sales, and bulk sales. The return attribute may be determined based on elements, including in-store returns, in-store exchanges, online returns, and online exchanges. The purchase order attribute may be determined based on elements including inventory ordered for brick and mortar stores and inventory ordered for the online store.

A subset of sub-analytical models, including 200-1, 200-2, 202-1, 202-2, 204-1, and 204-2 may be configured to identify elements associated with the purchase attribute. A subset of sub-analytical models, including 200-3, 202-3, and 204-3, may be configured to identify elements of the return attribute. A subset of sub-analytical models 200-4, 202-4, and 204-4 may be configured to identify elements associated with the purchase order attribute.

The identified elements may be used to identify the respective attribute for each line of business (e.g., a category). Furthermore, the identified attributes for each line of business may be used to determine the projected inventory of items for an entity.

As indicated above, a subset of sub-analytical models may be configured to identify elements of the purchase group. Sub-analytical models 200-1, 202-1, and 204-1 may identify the in-store sales element. Sub-analytical models 200-2 and 202-2 may identify the online sales element. Sub-analytical model 204-2 may identify the bulk sales element.

The sub-analytical models may be dependent on other sub-analytical models. That is, a sub-analytical model may be trained and executed using the output of another sub-analytical model. Furthermore, a sub-analytical model may take the output of another sub-analytical model as an input parameter to generate its output. The dependencies may be within the layers and span across layers.

For example, sub-analytical models 200-1-200-n may be independent of one another. Sub-analytical models 202-1-202-n may depend on one or more of sub-analytical models 200-1-200-n. Sub-analytical models 204-1-204-n may depend on one or more of sub-analytical models 200-1-200-n and 202-1-202-n.

In a given embodiment, dependency engine 102 may identify dependency relationships between sub-analytical models 200-1-200-n, 202-1-202-n, 204-1-204-n. Dependency engine 102 may determine that an input parameter of a given sub-analytical model corresponds with the output of a different sub-analytical model. In particular, dependency engine 102 may parse the code of the sub-analytical models. Dependency engine 102 may identify an input parameter received and used by a given sub-analytical model to identify a given element. Dependency engine 102 may traverse the code of other sub-analytical models to identify a different sub-analytical model configured to generate an output corresponding to the input parameter received and used by the given sub-analytical model.

Dependency engine 102 may generate a model dependency structure 122, including a definition of each identified dependency relationship between sub-analytical models 200-1-200-n, 202-1-202-n, 204-1-204-n. Model dependency structure 122 may be a graph object, including vertices and edges. Each vertex may represent a sub-analytical model, and each edge may represent a relationship or dependency between sub-analytical models. Therefore, dependency engine 102 may define a relationship between two sub-analytical models by connecting the vertex representing a given sub-analytical model and connecting the given sub-analytical model with a different sub-analytical model using an edge (e.g., arrow).

Each definition indicates that an output of a given analytical model is used to train a different analytical model. Model dependency structure 122 may be stored in database 120. As such, a definition of the dependency relationship between sub-analytical models 200-1 and 202-1 may indicate that the output of sub-analytical model 200-1 is used to train sub-analytical model 202-1.

Dependency engine 102 may generate script 105 using model dependency structure 122. Script 105 may be an automated script configured to generate instructions for task scheduler 110 for executing one or more of the analytical models. Script 105 may use model dependency structure 122 to generate the instructions. For example, script 105 may determine that a given analytical model is dependent on a different analytical model. Script 105 may include executable code to traverse the model dependency structure 122. As indicated above, the model dependency structure 122 may be stored in database 120 as a graph object. The graph object may include vertices and edges. The vertices may represent sub-analytical models. The edges (e.g., arrows) may indicate a dependency. Therefore, script 105 may identify dependencies from the model dependency structure 122 if one vertex is connected to an edge that points to another vertex. As such, script 105 may generate an instruction indicating the dependency between the two analytical models.

Continuing from the example above, dependency engine 102 may receive a request from application 144 to train sub-analytical model 202-1. Sub-analytical model 202-1 may be part of the subset of sub-analytical models configured to identify elements for the purchase attribute. Sub-analytical model 202-1 may be configured to identify the in-store sales element of the purchase attribute.

Dependency engine 102 may execute script 105 to generate an instruction to train sub-analytical model 202-1. Script 105 may identify the dependencies of sub-analytical model 202-1 using model dependency structure 122. Sub-analytical model 202-1 may depend on sub-analytical model 200-1. Sub-analytical model 200-1 may also be configured to identify the in-store sales element. Accordingly, script 105 may identify a definition of a dependency relationship between the sub-analytical model 202-1 and sub-analytical model 200-1 based on the edge connecting the vertex representing sub-analytical model 202-1 and another vertex representing sub-analytical model 200-1. Script 105 may determine that based on the edge connecting the two vertices, an output of sub-analytical model 200-1 is used to train the sub-analytical model 202-1.

Script 105 may generate the instruction for task scheduler 110 to train and execute sub-analytical model 202-1 using the definition of the dependency relationship between sub-analytical model 202-1 and sub-analytical model 200-1. Script 105 may include code for generating an executable instruction for task scheduler to execute the defined analytical models. Script 105 may be provided information about the type of task scheduler 110. The information may include the syntax and format accepted by task scheduler 110. Script 105 may use the syntax and format of task scheduler 110 to generate an instruction to be executed by task scheduler 110, in the syntax and format accepted by task scheduler 110. The instruction may include the sub-analytical models to be executed, the order of their execution, and the defined dependencies.

As a non-limiting example, task scheduler 110 may be a workflow management tool that can execute operations based on a provided instruction. The instruction may indicate the dependencies of the operations and order of the operations. Accordingly, the instruction may include a required( ) method for indicating one or more instantiated tasks on which the current task depends. The instruction may further include an output( ) method, which may indicate one or more target objects that the current task will produce when executed. Furthermore, the instruction may include a run( ) method, which executes the current task.

Continuing the above example, script 105 may traverse model dependency structure 122. Script 105 may identify the edge connecting the vertices of sub-analytical models 200-1 and 202-1. Based on the edge connecting the vertices of sub-analytical models 200-1 and 202-1, script 105 may determine that sub-analytical model 202-1 depends on sub-analytical model 200-1. Furthermore, script 105 may determine that sub-analytical model 202-1 uses the output from sub-analytical models 200-1 and 202-1 for training and execution. As a result, script 105 may generate an instruction for executing sub-analytical model 200-1 first and using the output of sub-analytical model 200-1 to train and execute sub-analytical model 202-1.

Script 105 may transmit the instruction to task scheduler 110. Task scheduler 110 may execute sub-analytical model 200-1 and subsequently execute sub-analytical model 202-1. Furthermore, task scheduler 110 may use the output of sub-analytical model 200-1 to train and execute sub-analytical model 202-1. Sub-analytical models 200-1 and 202-1 may be executed independently of any other sub-analytical models. This way, a developer may train sub-analytical model 202-1 without having to train any other sub-analytical model.

Furthermore, task scheduler 110 may capture the outputs of sub-analytical models 200-1 and 202-1 in an output file. In some embodiments, the output of sub-analytical model 200-1 may be stored in a given output file. In contrast, the output of sub-analytical model 202-1 may be stored in a different output file. In some embodiments, task scheduler 110 may return the outputs of sub-analytical models 200-1 and 202-1 to server 101, and dependency engine 102 may generate the output files for storing the outputs. The output file(s) may be stored in a temporary memory, such as cache or RAM, and deleted after a predetermined amount of time.

Dependency engine 102 may receive a separate request to train sub-analytical model 204-1. As indicated above, sub-analytical model 204-1 may identify the in-store sales element for the purchase attribute. Script 105 may identify the definition of a dependency relationship between sub-analytical model 204-1 and sub-analytical model 202-1 and the definition of a dependency relationship between sub-analytical models 202-1 and 200-1, based on an edge connecting vertices of sub-analytical models 204-1 and 200-1 and an edge connecting vertices of sub-analytical models 202-1 and 200-1, in model dependency structure 122. Script 105 may determine sub-analytical model 204-1 is trained using the output of sub-analytical model 202-1, and sub-analytical model 202-1 is trained using the output of sub-analytical model 200-1, based on the definition a dependency relationship between sub-analytical model 204-1 and sub-analytical model 200-1 and the definition of a dependency relationship between sub-analytical model 202-1 and sub-analytical model 200-1. Therefore, to train sub-analytical model 204-1, the output generated from executing sub-analytical model 200-1 is needed so that the sub-analytical model 202-2 may be trained and executed. The output of sub-analytical model 202-2 may be used to train and execute sub-analytical model 204-1.

However, script 105 may determine that the sub-analytical models 200-1 and 202-1 have been executed within a predetermined time interval. For example, script 105 may determine that sub-analytical models 200-1 and 202-1 have been executed within the past 15 minutes. Therefore, script 105 may determine sub-analytical models 200-1 and 202-1 do not need to be re-executed. Alternatively, script 105 may determine that sub-analytical models 200-1 and 202-1 do not have to be re-executed because the data processed by sub-analytical model 200-1 has not been altered since the last time sub-analytical models 200-1 and 202-1 were executed. As a result, script 105 may determine the output of sub-analytical models 200-1 and 202-1 would not change if re-executed. Therefore, script 105 may determine that sub-analytical models 200-1 and 202-1 do not need to be re-executed.

Script 105 may retrieve the outputs of sub-analytical model 202-1. Script 105 may generate an instruction for task scheduler 110 to train and execute sub-analytical model 204-1 using the output of sub-analytical model 202-1 retrieved from the output file. Script 105 may transmit the instruction to task scheduler 110.

As another non-limiting example, a developer may choose to train and execute a subset of sub-analytical models, such as sub-analytical models 202-1, 202-2, 204-1, and 204-2 in the purchase group. Dependency engine 102 may receive a request to train and execute sub-analytical models 202-1, 202-2, 204-1, and 204-2. Dependency engine 102 may execute script 105.

Script 105 may determine that sub-analytical models 202-1 and 202-2 depend on sub-analytical models 200-1 and 200-2 based on model dependency structure 122. In particular, script 105 may determine that an edge connects vertices for sub-analytical model 202-1 and sub-analytical model 200-1, in model dependency structure 122. Furthermore, script 105 may determine that an edge connects vertices for sub-analytical model 202-2 and sub-analytical model 200-2, in model dependency structure 122.

Additionally, script 105 may determine that an edge connects vertices for sub-analytical model 204-1 and sub-analytical model 202-1, in model dependency structure 122. Furthermore, script 105 may determine that an edge connects vertices for sub-analytical models 204-2 and 202-2.

In view of the above, script 105 may identify the following order of operations:

1. Execute sub-analytical models 200-1 and 200-2.

2. Train and execute sub-analytical model 200-1 using the output of sub-analytical model 200-1 and train and execute sub-analytical model 200-2 using the output of sub-analytical model 200-2.

3. Train and execute sub-analytical model 204-1 using the output of sub-analytical model 202-1 and train and execute sub-analytical model 204-2 using the output of sub-analytical model 202-2.

Script 105 may generate an instruction for task scheduler 110 to perform the above operations in the prescribed order. Script 105 may transmit the instruction to task scheduler 110. Task scheduler 110 may perform the above operations in the prescribed order. In this way, a developer is able to train the sub-analytical models configured to identify elements of the purchase attribute.

As another non-limiting example, system 100 may also be configured to identify dependencies of various tasks and execute the tasks based on the identified dependencies. Tasks may be a set of operations that include an input parameter and generate an output. A given task may be dependent on a different task. For example, the given task may use the output of the different task as its input parameter. Analytical models may be referred to as tasks. As such, server 101 may identify dependencies of tasks and generate instructions for executing the tasks based on the dependencies, as described above, with respect to the sub-analytical models.

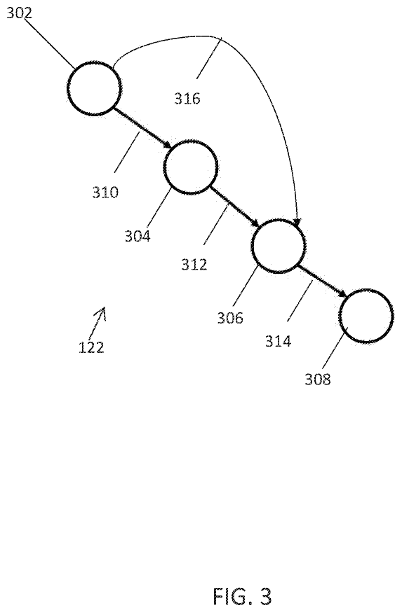

FIG. 3 is a block diagram of model dependency structure 122, according to an example embodiment. Model dependency structure 122 may be a graph object, including vertices 302-308 and edges 310-316. Edges may connect the vertices. Vertices 302-308 may represent sub-analytical models. Therefore, sub-analytical model 302 may be directly connected to 304 via edge 310 and sub-analytical model 306 via edge 316. Sub-analytical model 304 may be directly connected to sub-analytical model 306 via edge 312, and sub-analytical model 306 may be directly connected to sub-analytical model 308, via edge 314.

The edges may be arrows, and the direction of the arrow may indicate that a given sub-analytical model depends on the sub-analytical model pointed to by the arrow. Therefore, sub-analytical model 308 is independent and does not depend on other sub-analytical models. Sub-analytical model 306 depends on sub-analytical model 308. Sub-analytical model 304 depends on sub-analytical model 306. Sub-analytical model 302 depends on sub-analytical model 304 and sub-analytical model 306.

A script (e.g., script 105, as shown in FIG. 1) may use model dependency structure 122 to determine the definition of a dependency relationship between the sub-analytical models. The definition may be identified based on edges. For example, the script may determine sub-analytical model 306 is trained and executed using the output of sub-analytical model 308 based on edge 314. The script may use the identified dependencies to generate the instruction for the task scheduler (e.g., task scheduler 110, as shown in FIG. 1).

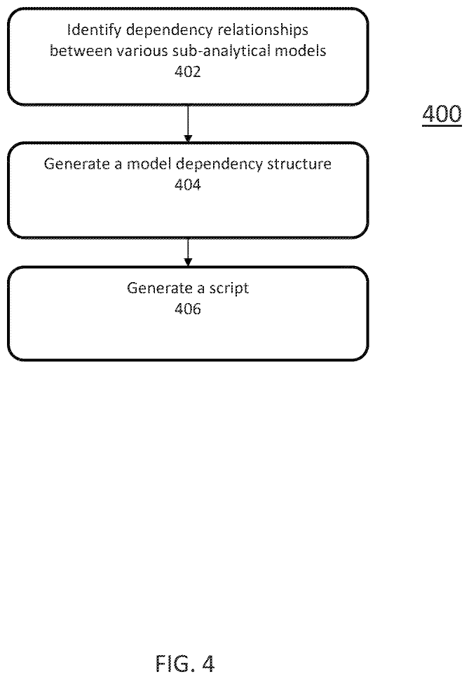

FIG. 4 is a flowchart illustrating a process for generating a script using a model dependency structure, according to some embodiments. Method 400 may be performed by processing logic that may comprise hardware (e.g., circuitry, dedicated logic, programmable logic, microcode, etc.), software (e.g., instructions executed on a processing device), or a combination thereof. It is to be appreciated that not all steps may be needed to perform the disclosure provided herein. Further, some of the steps may be performed simultaneously or in a different order than shown in FIG. 4, as will be understood by a person of ordinary skill in the art.

Method 400 shall be described with reference to FIG. 1. However, method 400 is not limited to that example embodiment.

In operation 402, server 101 identifies dependency relationships between various sub-analytical models. The sub-analytical models may be predictive models. Furthermore, the sub-analytical models may be part of a larger main analytical model and grouped based on a common attribute. For example, the main analytical model may be configured to identify a pattern about an aspect of an entity's operation. The main analytical model may use multiple attributes to identify the pattern. Each attribute may include multiple elements. The sub-analytical models may be grouped in subsets of sub-analytical models. Each subset of sub-analytical models may identify elements corresponding to a common attribute. The sub-analytical models may be dependent on one another. For example, server 101 may traverse the code of the sub-analytical models and identify that a given sub-analytical model's input parameter corresponds with a sub-analytical model's output. Therefore, the given sub-analytical model uses the sub-analytical model's output to identify an element. As such, the given sub-analytical model is dependent on the different sub-analytical model.

In operation 404, server 101 generates a model dependency structure, including a definition for each dependency relationship between various analytical models, based on the dependency relationships between various analytical models. The model dependency structure may be a graph object, including vertices connected by edges. The vertices may represent sub-analytical models, and the edges may represent a definition of a dependency relationship between the sub-analytical models. Therefore, server 101 may define a dependency relationship by connecting two vertices with an edge. Each definition indicates that an output of a given analytical model of the various analytical models is used to train a different analytical model of the various analytical models. As such, the different analytical model may be dependent on the given analytical model.

In operation 406, server 101 generates a script using the model dependency structure. The script may be configured to automatically generate instructions for a task scheduler for executing one or more of the various analytical models. In particular, the script may determine the dependencies of the sub-analytical models using the model dependency structure. The script may identify a dependency based on vertices, representing sub-analytical models, connected by an edge. The edge may be an arrow, and the direction of the arrow may indicate the dependency relationship. The script may use the dependencies to generate an instruction for a task scheduler. The instruction may indicate an order of executing sub-analytical models based on the dependencies.

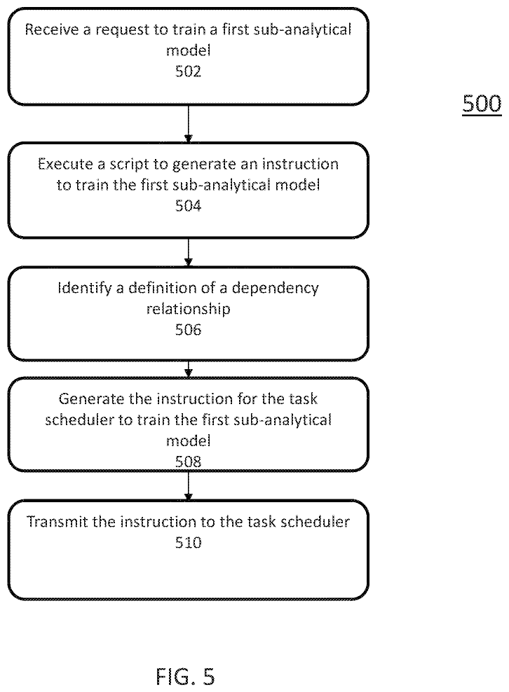

FIG. 5 is a flowchart illustrating a process for training an analytical model, according to some embodiments. Method 500 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 5, as will be understood by a person of ordinary skill in the art.

Method 500 shall be described with reference to FIG. 1. However, method 500 is not limited to that example embodiment.

In operation 502, server 101 receives a request to train a first sub-analytical model from various sub-analytical models. The first sub-analytical model may be a predictive analytical model. The first sub-analytical model may be trained using a first input parameter. The first sub-analytical model may be part of a main analytical model. The first sub-analytical model may be configured to identify an element of an attribute using the first input parameter. The attribute may be one of many attributes used by the main sub-analytical model to identify a pattern about an aspect of an entity's operation.

In operation 504, server 101 executes a script to generate an instruction to train the first sub-analytical model. Script 105 may be an automated script that may generate instructions for a task scheduler. In this regard, script 105 may identify a type of task scheduler and generate the instruction using the format and syntax corresponding to the type of task scheduler.

In operation 506, script 105 identifies a definition of a dependency relationship between the first sub-analytical model and a second sub-analytical model based on the model dependency structure. In particular, script 105 may identify the dependency relationship between the first sub-analytical model and the second analytical model based on a vertex representing the first sub-analytical model connected by an edge to another vertex representing a second sub-analytical model in model dependency structure 122. The edge may be an arrow. Script 105 may identify the definition of the dependency relationship based on the direction of the arrow. Therefore, the edge connecting the vertex representing the first sub-analytical model and the vertex representing second sub-analytical model may point to the vertex representing the second sub-analytical model. The definition that indicates an output of the second sub-analytical model is used to train the first sub-analytical model. Accordingly, script 105 may determine that the second sub-analytical model is to be executed before the first analytical model.

In operation 508, script 105 generates the instruction for the task scheduler to train the first sub-analytical model. The instruction may indicate an order to execute the first and second sub-analytical model based on the definition. As indicated above, script 105 may determine that the second sub-analytical model is to be executed before the first analytical model. This way, the output of the second sub-analytical model may be captured and used to train the second analytical model. The instruction may indicate executing the second sub-analytical model before the first analytical model.

In operation 510, script 105 transmits the instruction to the task scheduler. The task scheduler may execute the second sub-analytical model before executing the first sub-analytical model. Furthermore, the task scheduler may use the output of the second sub-analytical model to train the second analytical model. The first and second sub-analytical models may be executed and trained independently of any other sub-analytical models.

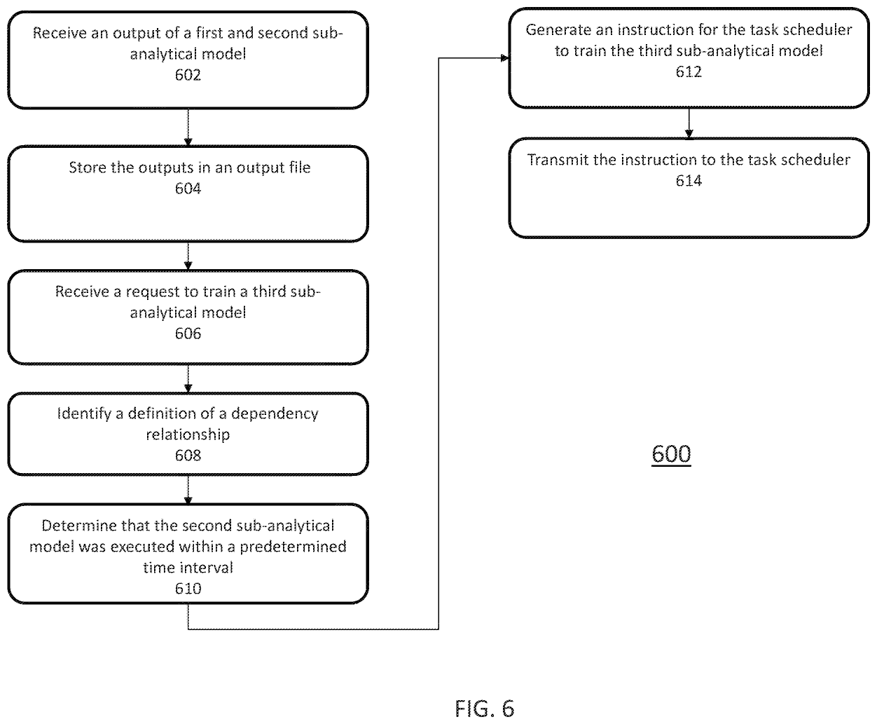

FIG. 6 is a flowchart illustrating a process for training an analytical model, according to some embodiments. Method 600 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 6, as will be understood by a person of ordinary skill in the art.

Method 600 shall be described with reference to FIG. 1. However, method 600 is not limited to that example embodiment.

In operation 602, server 101 receives outputs of the first and second sub-analytical models in response to executing the first and second sub-analytical models. The first and second analytical models may be part of a master analytical model. As indicated above, the first sub-analytical model may be dependent on the sub-second analytical model. The dependency may be defined in the definition of the dependency relationship between the first and second sub-analytical models. The definition may be included in the model dependency structure.

In operation 604, server 101 stores output in on output file of the first and second sub-analytical models. The output file may be temporarily stored in non-persistent memory such as cache or RAM.

In operation 606, server 101 receives a request to train a third sub-analytical model. Server 101 may execute script 105 in response to receiving the request. Script 105 may identify any dependency relationships for the third sub-analytical model based on the model dependency structure. Script 105 may identify each vertex connected to the vertex representing the third sub-analytical model.

In operation 608, script 105 identifies a definition of a dependency relationship between the third sub-analytical model and the second sub-analytical model based on the model dependency structure. Script 105 may determine that the vertex representing the third sub-analytical model is connected to the vertex connected to the second sub-analytical model, and the arrow is pointing at the second sub-analytical model. Therefore, the definition may indicate that the output of the second sub-analytical model is used to train the third analytical model. As such, the third sub-analytical model is dependent on the second analytical model.

In operation 610, script 105 determines that the second sub-analytical model was executed within a predetermined time interval. For example, script 105 may determine that the second sub-analytical model was executed within the past 5 minutes. Accordingly, the second sub-analytical model does not need to be executed again, as the data for executing the second sub-analytical model has not changed.

In operation 612, script 105 generates an instruction for the task scheduler to train the third sub-analytical model using the output of the second sub-analytical model stored in the output file. Therefore, instead of re-executing the second sub-analytical model, the task scheduler may train and execute the third sub-analytical model using the stored output.

In operation 614, script 105 transmits the instruction to the task scheduler. The task scheduler may train and execute the third sub-analytical model using the output of the second sub-analytical model stored in the output file.

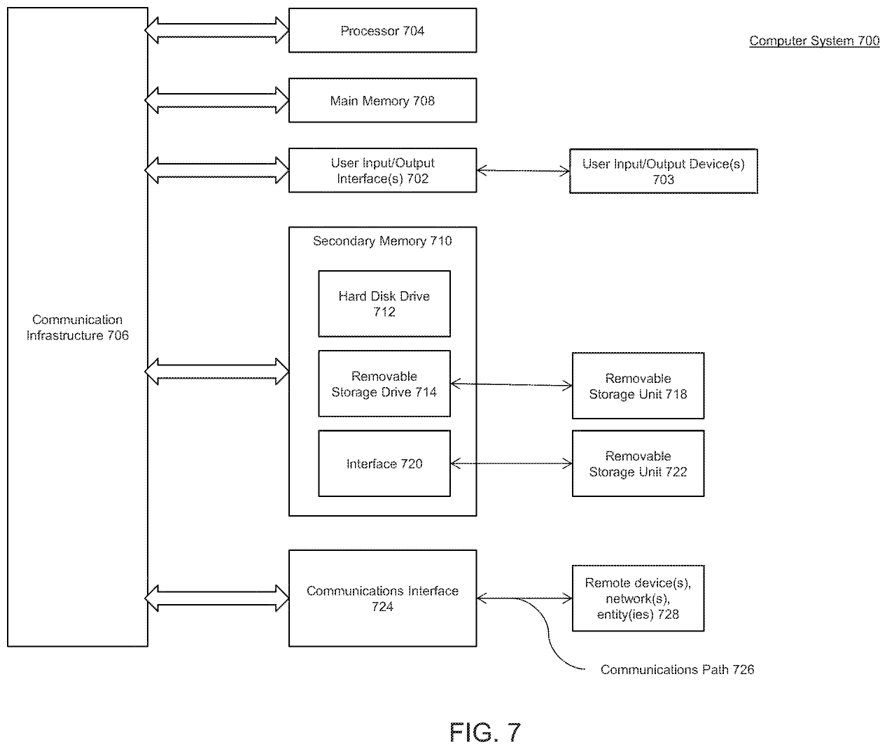

Various embodiments may be implemented, for example, using one or more computer systems, such as computer system 700 shown in FIG. 7. Computer system 700 may be used, for example, to implement methods 400, 500, and 600 of FIGS. 4-6. Furthermore, computer system 700 may be at least part of server 101, as shown in FIG. 1. For example, computer system 700 may determine dependencies between analytical models, determine an order the analytical models should be executed, and generate an instruction for executing the analytical models. Computer system 700 may be any computer capable of performing the functions described herein.

Computer system 700 may be any well-known computer capable of performing the functions described herein.

Computer system 700 includes one or more processors (also called central processing units, or CPUs), such as a processor 704. Processor 704 is connected to a communication infrastructure or bus 706.

One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main or primary memory 708, such as random access memory (RAM). Main memory 708 may include one or more levels of cache. Main memory 708 has stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer-usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 may include other means, instrumentalities, or other approaches for allowing computer programs and/or other instructions and/or data to be accessed by computer system 700. Such means, instrumentalities, or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

In an embodiment, a tangible, non-transitory apparatus or article of manufacture comprising a tangible, non-transitory computer-useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments may operate with software, hardware, and/or operating system implementations other than those described herein.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
generating, by one or more computing devices, a model dependency structure including a definition for each dependency relationship between a plurality of sub-analytical models of a main analytical model, wherein each definition indicates that an output of a given sub-analytical model in the plurality of sub-analytical models is used to train a different sub-analytical model in the plurality of sub-analytical models;
receiving, by the one or more computing devices, a first request to train a first sub-analytical model of a plurality of sub-analytical models;
identifying, by the one or more computing devices, a first definition of a first dependency relationship between the first sub-analytical model and a second sub-analytical model of the plurality of sub-analytical models based on the model dependency structure, wherein the first definition indicates that a first output of the second sub-analytical model is used to train the first sub-analytical model;
generating, by the one or more computing devices, a first instruction for a task scheduler to train the first sub-analytical model, the first instruction indicating an order to execute the first sub-analytical model and the second sub-analytical model based on the first definition;
transmitting, by the one or more computing devices, the first instruction to the task scheduler,
wherein the second sub-analytical model is executed before the first sub-analytical model, and the first output of the second sub-analytical model is used to train the first sub-analytical model.

2. The method of claim 1, further comprising generating, by the one or more computing devices, a script using the model dependency structure, wherein the script is configured to generate the first instruction.

3. The method of claim 1, further comprising separating, by the one or more computing devices, the plurality of sub-analytical models into different groups, based on an attribute of each sub-analytical model.

4. The method of claim 1, wherein the first sub-analytical model and the second sub-analytical model are executed independently of any other of the plurality of sub-analytical models.

5. The method of claim 1, further comprising storing, by the one or more computing devices, the output of the second sub-analytical model in an output file.

6. The method of claim 5, further comprising:
receiving, by the one or more computing devices, a second request to train a third sub-analytical model;
determining, by the one or more computing devices, a second definition of a second dependency relationship between the second sub-analytical model and the third sub-analytical model, wherein the second definition indicates that the first output of the second sub-analytical model is used to train the third sub-analytical model;
determining, by the one or more computing devices, the second sub-analytical model is executed within a predetermined time interval;
generating, by the one or more computing devices, a second instruction for the task scheduler to train the third sub-analytical model, the second instruction indicating using the first output of the second sub-analytical model stored in the output file to train the third sub-analytical model; and
transmitting, by the one or more computing devices, the second instruction to the task scheduler,
wherein the third sub-analytical model is executed using the first output of the second sub-analytical model retrieved from the output file.

7. The method of claim 5, further comprising deleting, by the one or more computing devices, the output file after a predetermined amount of time.

8. A system comprising:
a memory;
a processor coupled to the memory, the processor configured to:
generate a model dependency structure including a definition for each dependency relationship between a plurality of sub-analytical models of a main analytical model, wherein each definition indicates that an output of a given sub-analytical model in the plurality of sub-analytical models is used to train a different sub-analytical model in the plurality of sub-analytical models;
receive a first request to train a first sub-analytical model of a plurality of sub-analytical models;
identify a first definition of a first dependency relationship between the first sub-analytical model and a second sub-analytical model of the plurality of sub-analytical models based on the model dependency structure, wherein the first definition indicates that a first output of the second sub-analytical model is used to train the first sub-analytical model;
generate a first instruction for a task scheduler to train the first sub-analytical model, the first instruction indicating an order to execute the first sub-analytical model and the second sub-analytical model based on the first definition;
transmit the first instruction to the task scheduler,
wherein the second sub-analytical model is executed before the first sub-analytical model, and the first output of the second sub-analytical model is used to train the first sub-analytical model.

9. The system of claim 8, the processor further configured to generate a script using the model dependency structure, wherein the script is configured to generate the first instruction.

10. The system of claim 8, the processor further configured to separate the plurality of sub-analytical models into different groups based on an attribute of each sub-analytical model.

11. The system of claim 8, wherein the first sub-analytical model and the second sub-analytical model are executed independently of any other of the plurality of sub-analytical models.

12. The system of claim 8, the processor further configured to store the output of the second sub-analytical model in an output file.

13. The system of claim 12, the processor further configured to:
receive a second request to train a third sub-analytical model;
determine a second definition of a second dependency relationship between the second sub-analytical model and the third sub-analytical model, wherein the second definition indicates that the first output of the second sub-analytical model is used to train the third sub-analytical model;
determine the second sub-analytical model is executed within a predetermined time interval;
generate a second instruction for the task scheduler to train the third sub-analytical model, the second instruction indicating using the first output of the second sub-analytical model stored in the output file to train the third sub-analytical model; and
transmit the second instruction to the task scheduler,
wherein the third sub-analytical model is executed using the first output of the second sub-analytical model retrieved from the output file.

14. The system of claim 12, further comprising deleting, by the one or more computing devices, the output file after a predetermined amount of time.

15. A non-transitory computer-readable medium having instructions stored thereon that, when executed by at least one computing device, cause the at least one computing device to perform operations comprising:
generating a model dependency structure including a definition for each dependency relationship between a plurality of sub-analytical models of a main analytical model, wherein each definition indicates that an output of a given sub-analytical model in the plurality of sub-analytical models is used to train a different sub-analytical model in the plurality of sub-analytical models;
receiving a first request to train a first sub-analytical model of a plurality of sub-analytical models;
identifying a first definition of a first dependency relationship between the first sub-analytical model and a second sub-analytical model of the plurality of sub-analytical models based on the model dependency structure, wherein the first definition indicates that a first output of the second sub-analytical model is used to train the first sub-analytical model;
generating a first instruction for a task scheduler to train the first sub-analytical model, the first instruction indicating an order to execute the first sub-analytical model and the second sub-analytical model based on the first definition;
transmitting the first instruction to the task scheduler,
wherein the second sub-analytical model is executed before the first sub-analytical model, and the first output of the second sub-analytical model is used to train the first sub-analytical model.

16. The non-transitory computer-readable medium of claim 15, the operations further comprising generating a script using the model dependency structure, wherein the script is configured to generate the first instruction.

17. The non-transitory computer-readable medium of claim 15, the operations further comprising separating the plurality of sub-analytical models into different groups based on an attribute of each sub-analytical model.

18. The non-transitory computer-readable medium of claim 15, wherein the first sub-analytical model and the second sub-analytical model are executed independently of any other of the plurality of sub-analytical models.

19. The non-transitory computer-readable medium of claim 15, the operations further comprising storing the output of the second sub-analytical model in an output file.

20. The non-transitory computer-readable medium of claim 19, the operations further comprising:
receiving a second request to train a third sub-analytical model;
determining a second definition of a second dependency relationship between the second sub-analytical model and the third sub-analytical model, wherein the second definition indicates that the first output of the second sub-analytical model is used to train the third sub-analytical model;
determining the second sub-analytical model is executed within a predetermined time interval;
generating a second instruction for the task scheduler to train the third sub-analytical model, the second instruction indicating using the first output of the second sub-analytical model stored in the output file to train the third sub-analytical model; and
transmitting the second instruction to the task scheduler,
wherein the third sub-analytical model is executed using the first output of the second sub-analytical model retrieved from the output file.
